(19) United States
(12) Patent Application Publication
(10) Pub. No.: US 2026/0280628 A1
(43) Pub. Date: Sep. 17, 2026

(54) TECHNOLOGIES FOR SUPPORTING CODEBOOK-BASED TRANSMISSIONS

(71) Applicant: Apple Inc., Cupertino, CA (US)

(72) Inventors: Haitong Sun, San Jose, CA (US); Ankit Bhamri, Haar (DE); Chunxuan Ye, San Diego, CA (US); Dawei Zhang, Saratoga, CA (US); Wei Zeng, Saratoga, CA (US); Huaning Niu, San Jose, CA (US); Dan Wu, Beijing (CN)

(73) Assignee: Apple Inc., Cupertino, CA (US)

(21) Appl. No.: 18/871,451

(22) PCT Filed: Dec. 3, 2023
(86) PCT No.: PCT/CN2023/136003

§ 371 Date: Dec. 3, 2024

(51) Int. Cl. H04B 7/0456

(52) U.S. Cl. CPC H04B 7/0479

(57) ABSTRACT

The present application relates to devices and components including apparatus, systems, and methods for supporting codebook-based transmissions using more than 32 channel state information-reference signal ports.

### BACKGROUND

Third Generation Partnership Project (3GPP) Technical Specifications (TSs) define standards for wireless networks. These TSs describe aspects related to providing multiple-input, multiple-output (MIMO) communication over a radio interface.

### BRIEF DESCRIPTION OF THE DRAWINGS

FIG. 1 illustrates a network environment in accordance with some embodiments.

FIG. 2 illustrates an antenna architecture in accordance with some embodiments.

FIG. 3 illustrates an operation flow/algorithmic structure in accordance with some embodiments.

FIG. 4 illustrates another operation flow/algorithmic structure in accordance with some embodiments.

FIG. 5 illustrates another operation flow/algorithmic structure in accordance with some embodiments.

FIG. 6 illustrates a user equipment in accordance with some embodiments.

FIG. 7 illustrates a base station in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

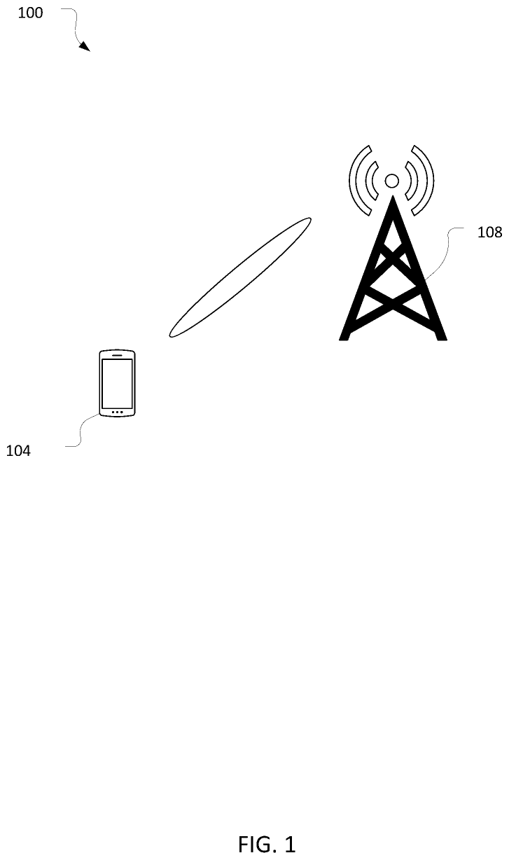

FIG. 1 illustrates a network environment 100 in accordance with some embodiments. The network environment 100 may include a user equipment 104 and a base station 108. In some embodiments, the base station 108 may provide one or more wireless access cells through which the UE 104 may communicate with a cellular network. The UE 104 and the base station 108 may communicate over air interfaces compatible with Fifth Generation (5G) NR, Sixth Generation (6G), or later system standards as provided by 3GPP TSs.

The base station 108 may transmit downlink reference signals that may be measured by the UE 104. The downlink reference signals may include, for example, a channel state information-reference signal (CSI-RS). The UE 104 may measure the CSI-RS to obtain a channel matrix. The UE 104 may then determine a precoding matrix that provides the best response (for example, highest energy) for the channel matrix. The UE 104 may then provide the base station 108 within an indication of the preferred precoding matrix to be used for a downlink transmission (for example, a physical downlink shared channel (PDSCH) transmission) from the base station. The base station may or may not use the precoding matrix for subsequent PDSCH transmission. To provide the indication of the preferred precoding matrix, the UE 104 may transmit a precoding matrix indicator (PMI) that identifies the precoding matrix from a predefined codebook.

The design of downlink CSI codebooks have evolved through various 3GPP Releases. In Release 15, four codebook types were supported: a Type I single-panel codebook (typeI—SinglePanel); a Type I multi-panel codebook (typeI—MultiPanel), a Type II codebook (typeII) and a Type II Port Selection Codebook (typeII—PortSelection). In Release 16, the Type II codebooks were enhanced for overhead reduction by spatial discrete Fourier transfer (DFT) basis. These codebooks are referred to as Enhanced Type II Codebook (typeII—r16) and Enhanced Type II Port Selection Codebook (TypeII—PortSelection—r16). In Release 17, the Type II Port Selection Codebook was further enhanced for channels with partial reciprocity. This codebook may be referred to as Further Enhanced Type II Port Selection Codebook (typeII—PortSelection—r17). In Release 18, enhancements were presented to the Type II codebooks for coherent joint transmission (CJT) with up to 4 transmit-receive points (TRPs). Enhancements were also presented to Type II codebooks for CSI prediction with time domain compression of multiple PMI by spatial/Doppler domain DFT bases. These enhancements were based on both typeII—r16 and typeII—PortSelection—r17.

Using a Type I codebook, the UE 104 may select a single spatial basis with a structured PMI construction. Codebooks for ranks 1/2, 3/4, 5/6, 7, and 8 adopt different designs. The design for codebooks for ranks 3/4 are different for situations in which the base station 108 has less than 16 CSI-RS ports and for situations in which the base station 108 has 16 or more CSI-RS ports. In situations in which the base station 108 has 16 or more CSI-RS ports, different spatial bases may be used.

A Type II codebook may include a W₁*W₂*W/structure, where W₁ is a spatial basis/port selection; W_{f} is a frequency basis selection; and W₂ is partial linear combination coefficient feedback.

Current NR networks support a maximum of 32 CSI-RS ports for downlink CSI acquisition and multiple-input, multiple-output (MIMO) operation. Consequentially, the 3GPP TSs only support DL CSI (PMI) codebook for up to 32 ports. However, it may be both desirable and feasible to deploy more than 32 antenna elements, especially for mid- and high-frequency bands. If more than 32 antenna elements are deployed in current networks, operators and infrastructure-vendors need to perform transparent antenna elements to CSI-RS port mapping. For example, for 128 antenna elements, 4 antenna elements need to be mapped to one CSI-RS port. The mapping can be implemented by fixed or semi-static beamforming, for example, with certain down-tilt. However, this fixed or semi-static beamforming may perform sub-optimally as is difficult to dynamically adapt to different circumstances (e.g., location, channel condition, channel variation, etc.) of various UEs.

Embodiments of the present disclosure describe codebook enhancements to support more than 32 CSI-RS ports. Various embodiments may include codebooks that support, for example, 48, 64, 72, 96, or 128 CSI-RS ports at the base station 108. Given that the codebooks may depend on antenna configurations, some embodiments also describe new antenna architectures that may be used by the base station 108. Some embodiments also describe these codebook enhancements with respect to Release 15 Type I Single-Panel Codebooks, for example, typeI-SinglePanel.

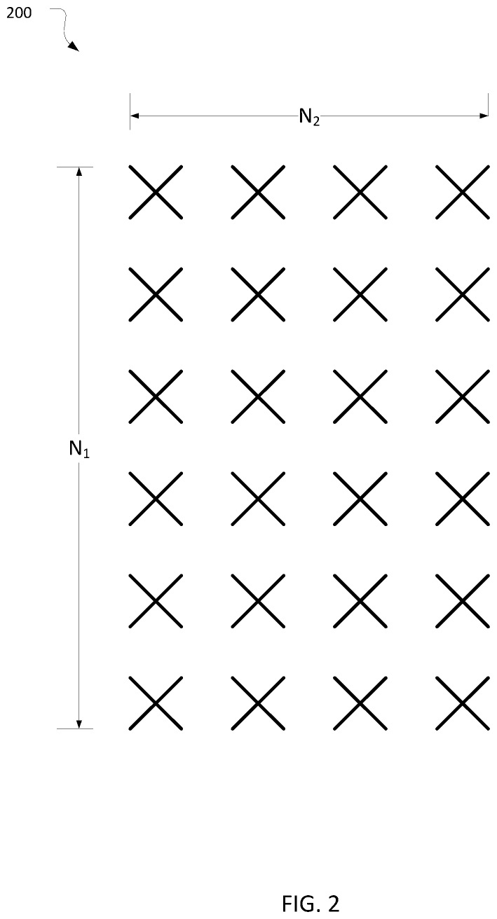

FIG. 2 illustrates an antenna architecture 200 in accordance with some embodiments. The antenna architecture 200 may be implemented within the base station 108. Each of the Xs illustrated in antenna architecture 200 may represent an antenna element location. Each antenna element location may include antenna elements coupled to two CSI-RS ports. A first CSI-RS port at a particular antenna element location may provide a signal with a horizontal polarization to a first antenna element (or elements) at the location. A second CSI-RS port at the particular antenna element location may provide a signal with a vertical polarization to a second antenna element (or elements) at the location. Accordingly, one antenna element location may provide two Tx DL operation and may support two layers.

Adjacent antenna elements may be equally separated from one another in the horizontal direction. Similarly, adjacent antenna elements may be equally separated from one another in the vertical direction. The horizontal separation may be equal to or different from the vertical separation.

The antenna architecture 200 may include N₁ antenna element locations in a vertical direction and N₂ antenna element locations in a horizontal direction. As shown, the antenna architecture 200 has N₁ equal to six and N₂ equal to four. This may correspond to the base station 108 having a total of 48 CSI-RS antenna ports. In other embodiments, the base station 108 may have 64, 72, 96, or 128 CSI-RS antenna ports. In various embodiments, the dimensions of the antenna architectures of the base station (for example, N₁ and N₂) may be given with respect to the number of CSI-RS antenna ports based on Table 1.

TABLE 1

| Number of CSI-RS antenna ports | (N₁, N₂) |
|---|---|
| 48 | (6, 4) |
| | (8, 3) |
| | (12, 2) |
| | (24, 1) |
| 64 | (8, 4) |
| | (16, 2) |
| | (32, 1) |
| 72 | (6, 6) |
| | (9, 4) |
| | (12, 3) |
| | (18, 2) |
| | (36, 1) |
| 96 | (8, 6) |
| | (12, 4) |
| | (16, 3) |
| | (24, 2) |
| | (48, 1) |
| 128 | (8, 8) |
| | (16, 4) |
| | (32, 2) |
| | (64, 1) |

The antenna architectures having different N₁ and N₂ values may be associated with different DFT basis correlations. These correlations may be used for spatial basis selection for Type I codebooks. Thus, embodiments describe enhancements of Type I single-panel codebooks to enable these different architectures.

In some embodiments, the base station 108 may configure the UE 104 to use a Type I Single Panel codebook by using radio resource control (RRC) signaling to transmit a codebook configuration (CodebookConfig) information element (IE) within a CSI report configuration (CSI-reportConfig) IE. The CodebookConfig IE may include a codebook type set to “typeI” and a subtype set to “typeI—SinglePanel.”

A first aspect of enhancing a codebook, referred to as aspect 1.1, describes a Type I Single Panel Codebook configured for rank 1 or rank 2 communications to be used when the base station 108 has more than 32 CSI-RS ports, e.g., 48, 64, 72, 96, or 128 CSI-RS ports.

In some embodiments, the codebook may be parameterized based on a combination of antenna architecture (for example, N₁ and N₂ values) and spatial domain oversampling factors. The spatial domain oversampling factors may include a vertical oversampling factor O₁ and a horizontal oversampling factor O₂. The number of possible beams in a vertical dimension may be provided by N₁*O₁, while the number of possible beams in a horizontal dimension may be provided by N₂*O₂.

In some instances, O₁ and O₂ may be set as follows: O₁=4 if N₁>1, otherwise, O₁=1; and O₂=4 if N₂>1, otherwise, O₂=1. In some embodiments, given the relatively larger N values, some embodiments may reduce the O values to better manage the overhead associated with searching and feeding back information on all possible DFT bases. For example, in these embodiments, O₁ and O₂ may be reduced to: O₁=2 if N₁>1, otherwise, O₁=1; and O₂=2 if N₂>1, otherwise, O₂=1.

For a particular (N₁, N₂) configuration with more than 32 CSI-RS ports (for example, N₁*N₂≥24), O₁ and O₂ may be determined according to one or more of the following options. In a first option, O₁ and O₂ can be configured by the network (for example, base station 108) via radio resource control (RRC) signaling. For example, the base station 108 may transmit an indication of the O values in an RRC information element (IE) as part of configuration information. In a second option, the O₁ and O₂ may be fixed with respect to different N₁ and N₂ values. For example, the relationship between the O values and the N values may be defined in a 3GPP TS. Thus, the base station 108 may provide an indication of the N values to the UE in, for example, a PDSCH, serving-cell, or CSI-report configuration, and the UE 104 may use that information to determine the corresponding O values.

Upon determining the O and N values of a particular situation, the UE 104 may access an appropriate codebook for determining the precoding information (for example, PMI) that is to be fed back to the base station 108.

A second aspect of enhancing a codebook, referred to as aspect 1.2, describes a Type I Single Panel Codebook configured for rank 2 communications to be used when the base station 108 has more than 32 CSI-RS ports, e.g., 48, 64, 72, 96, or 128 CSI-RS ports.

A baseline design may be provided by

$$W = [ \begin{matrix}{w}_{0 , 0} & {w}_{0 , 1} \\ {w}_{1 , 0} & {w}_{1 , 1}\end{matrix} ] ,$$

w_{r,l} where r is a polarization index and l is a layer index.

In some embodiments, precoders of layer 0 (for example, w_{0,0} and w_{1,0}) may both use the same selected spatial basis, while precoders of layer 1 (for example, w_{0,1} and w_{1,1}) may both use the same selected spatial basis. The selected spatial basis used by w_{0,1} and w_{1,1} may be offset {k₁, k₂} from the spatial basis used by w_{0,0} and w_{1,0}.

In general, the offsets may be in integer values of the oversampling factors to ensure orthogonality between the different spatial bases. The value k₁ may represent a difference, with respect to first and second spatial bases, in vertical phase change (e.g., phase change between elements at adjacent locations in the vertical direction). The value k₂ may represent a difference, with respect to first and second spatial bases, in horizontal phase change (e.g., phase change between elements at adjacent locations in the horizontal direction). Thus, an offset {O₁, O₂} would indicate: the vertical phase change according to the first spatial basis differs from the vertical phase change according to the second spatial basis by O₁ (which corresponds to 2π/N₁); and the horizontal phase change according to the first spatial basis differs from the horizontal phase change according to the second spatial basis by O₂ (which corresponds to 2π/N₂).

In some embodiments, {k₁, k₂} can have a number of options, based on N values, as follows: for N₁>N₂>1, {k₁, k₂}∈{(O₁, 0), (0, O₂), (O₁, O₂), (2O₁, 0), (2O₁, O₂), (3O₁, 0), (3O₁, O₂)}; and for N₁=N₂>1, {k₁, k₂}∈{(O₁, 0), (0, O₂), (O₁, O₂), (2O₁, 0), (2O₁, O₂), (0, 2O₂), (O₁, 2O₂)}.

In some embodiments, {k₁, k₂} can have a larger step size and be defined as follows: for N₁>N₂>1, {k₁, k₂}∈{(2O₁, 0), (0, 2O₂), (4O₁, 0)}; and for N₁=N₂>1, {k₁, k₂}∈{(2O₁, 0), (0, 2O₂), (2O₁, 2O₂)}. Providing the larger step size may decrease complexity of feeding back the precoding information.

A third aspect of enhancing a codebook, referred to as aspect 1.3, describes a Type I Single Panel Codebook configured for rank 3 or rank 4 communications to be used when the base station 108 has more than 32 CSI-RS ports, e.g., 48, 64, 72, 96, or 128 CSI-RS ports.

A baseline design may be provided by

$$W = [ \begin{matrix}{w}_{0 , 0} & {w}_{0 , 1} & {w}_{0 , 2} & {w}_{0 , 3} \\ {w}_{1 , 0} & {w}_{1 , 1} & {w}_{1 , 2} & {w}_{1 , 3}\end{matrix} ] ,$$

w_{r,l} where r is a polarization index and l is a layer index.

In some embodiments, precoders of layers 0 and 2 (for example, w_{0,0}, w_{1,0}, w_{0,2}, w_{1,2}) may use the same selected spatial basis, while precoders of layers 1 and 3 (for example, w_{0,1}, w_{1,1}, w_{0,3}, w_{1,3}) may use the same selected spatial basis. For rank 3 communications, layer 3 may not be included. The selected spatial basis used by w_{0,1}, w_{1,1}, w_{0,3}, w_{1,3} may be offset {k₁, k₂} from the spatial basis used by w_{0,0}, w_{1,0}, w_{0,2}, w_{1,2}.

In some embodiments, {k₁, k₂} can have a number of options, based on N values, as follows: for N₁≥N₂>1, {k₁, k₂}∈{O₁, 0), (0, O₂), (O₁, O₂), (2O₁, 0)}; and for N₂=1, {k₁, k₂}∈{O₁, 0), (2O₁, 0), (3O₁, 0), (4O₁, 0)}.

In some embodiments, if N₁=N₂>1, {k₁, k₂}∈{(O₁, 0), (0, O₂), (O₁, O₂)}.

In some embodiments, the PMI the UE 104 reports may include an indication of the first spatial basis and the offset. The base station 108, upon receiving the PMI, may then determine the second spatial basis based on the reported first spatial basis and the offset.

A fourth aspect of enhancing a codebook, referred to as aspect 1.4, describes selection of a spatial basis using a Type I Single Panel Codebook configured for rank 3 or rank 4 communications as described with respect to the aspect 1.3, for example.

As described above, the UE 104 may select a spatial basis for w_{0,0}, w_{1,0}, w_{0,2}, w_{1,2}. Doing this by searching all beams in the vertical direction (e.g., N₁*O₁ beams) and all beams in the horizontal direction (e.g., N₂*O₂ beams) may be excessively burdensome when the base station has 48 CSI-RS ports or more. Thus, in accordance with aspect 1.4, the spatial basis may be selected by searching a subset of the possible beams.

In the vertical direction, the beam or beam group, i_{1,1}, may be selected from 0, 1, . . . (NO₁−1). The value N may depend on N or the number of CSI-RS ports. For example, N may be defined as: N=N₁/2 for 48 CSI-RS ports; N=N₁/4 for 64 CSI-RS ports; N=N₁/3 for 72 CSI-RS ports; N=N₁/4 for 96 CSI-RS ports; or N=N₁/4 for 128 CSI-RS ports.

In the horizontal direction, the beam or beam group, i_{1,2}, may be selected from 0, 1, . . . (MO₂−1). The value M may depend on N₂ or the number of CSI-RS ports. For example, M may be defined as: M=N₂ for N₂≤3; or M=N₂/2 for N₂>3.

A fifth aspect of enhancing a codebook, referred to as aspect 1.5, describes a Type I Single Panel Codebook configured for rank 5 or rank 6 communications to be used when the base station 108 has more than 32 CSI-RS ports, e.g., 48, 64, 72, 96, or 128 CSI-RS ports.

A baseline design may be provided by

$$W = [ \begin{matrix}{w}_{0 , 0} & {w}_{0 , 1} & {w}_{0 , 2} & {w}_{0 , 3} & {w}_{0 , 4} & {w}_{0 , 5} \\ {w}_{1 , 0} & {w}_{1 , 1} & {w}_{1 , 2} & {w}_{1 , 3} & {w}_{1 , 4} & {w}_{1 , 5}\end{matrix} ] ,$$

w_{r,l} where r is a polarization index and l is a layer index.

In some embodiments, precoders of layers 0 and 1 (for example, w_{0,0}, w_{1,0}, w_{0,1}, w_{1,1}) may use the same selected spatial basis b_{0,0}, precoders of layers 2 and 3 (for example, w_{0,2}, w_{1,2}, w_{0,3}, w_{1,3}) may use the same selected spatial basis b_{1,1}; and precoders of layers 4 and 5 (for example, w_{0,4}, w_{1,4}, w_{0,5}, w_{1,5}) may use the same selected spatial basis b_{2,2}. For rank 5 communications, layer 5 may not be included.

The offset between selected bases may be based on N₂ values. For example, for N₂=1, b_{1,1} offset to b_{0,0} is (O₁, 0) and b_{2,2} offset to b_{0,0} is (2O₁, 0); and for N₂>1, b_{1,1} offset to b_{0,0} is (O_{1,0}) and b_{2,2} offset to b_{0,0} is (O₁, O₂).

A sixth aspect of enhancing a codebook, referred to as aspect 1.6, describes a Type I Single Panel Codebook configured for rank 7 communications to be used when the base station 108 has more than 32 CSI-RS ports, e.g., 48, 64, 72, 96, or 128 CSI-RS ports.

A baseline design may be provided by

$$W = [ \begin{matrix}{w}_{0 , 0} & {w}_{0 , 1} & {w}_{0 , 2} & {w}_{0 , 3} & {w}_{0 , 4} & {w}_{0 , 5} & {w}_{0 , 6} \\ {w}_{1 , 0} & {w}_{1 , 1} & {w}_{1 , 2} & {w}_{1 , 3} & {w}_{1 , 4} & {w}_{1 , 5} & {w}_{1 , 6}\end{matrix} ] ,$$

w_{r,l} where r is a polarization index and l is a layer index.

In some embodiments, precoders of layers 0 and 1 (for example, w_{0,0}, w_{1,0}, w_{0,1}, w_{1,1}) may use the same selected spatial basis b_{0,0}, precoders of layer 2 (for example, w_{0,2}, w_{1,2}) may use the same selected spatial basis b_{1,1}; precoders of layers 3 and 4 (for example, w_{0,3}, w_{1,3}, w_{0.4}, w_{1,4}) may use the same selected spatial basis b_{2,2}; and precoders of layers 5 and 6 (for example, w_{0,5}, w_{1,5}, w_{0,6}, w_{1,6}) may use the same selected spatial basis b_{3,3}.

This embodiment describes layer 2 being the single layer associated with one spatial basis, while the other layers are associated with respective spatial layers in pairwise manners. However, in other embodiments, another layer may be selected to be the single layer associated with one spatial basis.

The offset between selected bases may be based on N₂ values. For example, for N₂=1, b_{1,1} offset to b_{0,0} is (O_{1,0}), b_{2,2} offset to b_{0,0} is (2O₁, 0), and b_{3,3} offset to b_{0,0} is (3O₁, 0); and for N₂>1, b_{1,1} offset to b_{0,0} is (O₁, 0), b_{2,2} offset to b_{0,0} is (0, O₂), and b_{3,3} offset to b_{0,0} is (O₁, O₂).

A seventh aspect of enhancing a codebook, referred to as aspect 1.7, describes a Type I Single Panel Codebook configured for rank 8 communications to be used when the base station 108 has more than 32 CSI-RS ports, e.g., 48, 64, 72, 96, or 128 CSI-RS ports.

A baseline codebook design may be provided by

$$W = [ \begin{matrix}{w}_{0 , 0} & {w}_{0 , 1} & {w}_{0 , 2} & {w}_{0 , 3} & {w}_{0 , 4} & {w}_{0 , 5} & {w}_{0 , 6} & {w}_{0 , 7} \\ {w}_{1 , 0} & {w}_{1 , 1} & {w}_{1 , 2} & {w}_{1 , 3} & {w}_{1 , 4} & {w}_{1 , 5} & {w}_{1 , 6} & {w}_{1 , 7}\end{matrix} ] ,$$

w_{r,l} where r is a polarization index and l is a layer index.

In some embodiments, precoders of layers 0 and 1 (for example, w_{0,0}, w_{1,0}, w_{0,1}, w_{1,1}) may use the same selected spatial basis b_{0,0}, precoders of layers 2 and 3 (for example, w_{0,2}, w_{1,2}, w_{0,3}, w_{1,3}) may use the same selected spatial basis b_{1,1}; precoders of layers 4 and 5 (for example, w_{0,4}, w_{1,4}, w_{0,5}, w_{1,5}) may use the same selected spatial basis b_{2,2}; and precoders of layers 6 and 7 (for example, w_{0,6}, w_{1,6}, w_{0,7}, w_{1,7}) may use the same selected spatial basis b_{3,3}.

The offset between selected bases may be based on N₂ values. For example, for N₂=1, b_{1,1} offset to b_{0,0} is (O₁, 0), b_{2,2} offset to b_{0,0} is (2O₁, 0), and b_{3,3} offset to b_{0,0} is (3O₁, 0); and for N₂>1, b_{1,1} offset to b_{0,0} is (O_{1,0}), b_{2,2} offset to b_{0,0} is (0, O₂), and b_{3,3} offset to b_{0,0} is (O₁, O₂).

An eighth aspect of enhancing a codebook, referred to as aspect 1.8, describes selection of a spatial basis using a Type I Single Panel Codebook configured for rank 7 or rank 8 communications as described with respect to the aspects 1.6 or 1.7, for example.

As described above, the UE 104 may select a spatial basis for w_{0,0}, w_{1,0}, w_{0,2}, w_{1,2}. In accordance with aspect 1.8, the spatial basis may be selected by searching a subset of the possible beams.

In the vertical direction, the beam or beam group, i_{1,1}, may be selected from 0, 1, . . . (NO₁−1). The value N may depend on N or the number of CSI-RS ports. For example, N may be defined as: N=N₁/2 for 48 CSI-RS ports; N=N₁/4 for 64 CSI-RS ports; N=N₁/3 for 72 CSI-RS ports; N=N₁/4 for 96 CSI-RS ports; or N=N₁/4 for 128 CSI-RS ports.

In the horizontal direction, the beam or beam group, i_{1,2}, may be selected from 0, 1, . . . (MO₂−1). The value M may depend on N₂ or the number of CSI-RS ports. For example, M may be defined as: M=N₂ for N₂≤3; or M=N₂/2 for N₂>3.

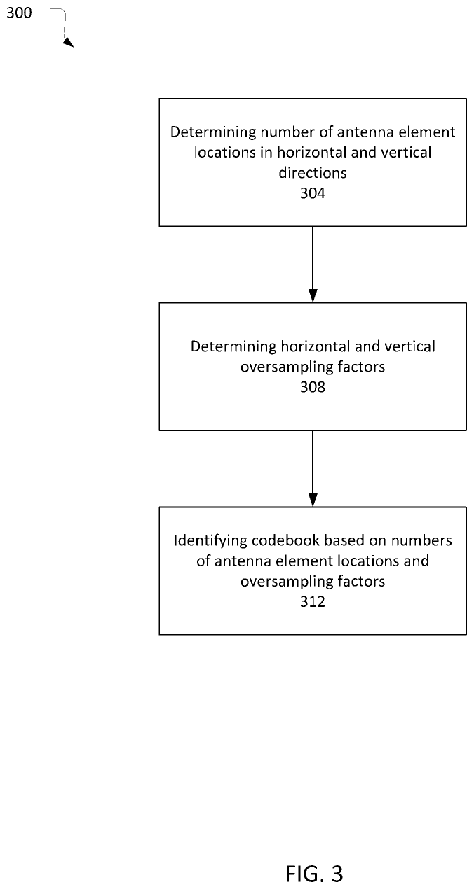

FIG. 3 illustrates an operation flow/algorithmic structure 300 in accordance with some embodiments. The operation flow/algorithmic structure 300 may be implemented by a UE such as UE 104, UE 600, or components therein, for example, processors 604.

The operation flow/algorithmic structure 300 may include, at 304, determining a number of antenna elements locations in a horizontal and vertical directions. Each antenna element location may correspond to a pair of CSI-RS ports at a base station. As used herein, determining antenna element locations in the vertical or horizontal directions may be similar to, and substantially interchangeable with, determining CSI-RS ports associated with the vertical or horizontal directions.

In some embodiments, the number of antenna element locations may be signaled to the UE from the base station. For example, the information may be transmitted in a configuration IE by RRC signaling.

The operation flow/algorithmic structure 300 may further include, at 308, determining horizontal and vertical oversampling factors. In some embodiments, the oversampling factors may be signaled to the UE from the base station. For example, the information may be transmitted in a configuration IE by RRC signaling. The oversampling factors may be signaled to the UE with the number of antenna element locations or separate therefrom.

In some embodiments, the oversampling factors may be determined based on the number of antenna element locations. For example, in some embodiments the vertical oversampling factor may be two if the number of antenna element locations in the vertical direction is greater than one, and the horizontal oversampling factor may be two if the number of antenna element locations in the horizontal direction is greater than one.

The operation flow/algorithmic structure 300 may further include, at 312, identifying a codebook based on the numbers of antenna element locations and oversampling factors. In some embodiments, the UE may be configured with a number of predefined codebooks. The codebooks may be predefined by, for example, a 3GPP TS. In some embodiments, the UE will reference a particular codebook from the predefined codebooks based on the antenna element configuration (for example, number of antenna element locations in the vertical and horizontal directions) and the configured oversampling factors.

As described elsewhere herein, the codebook identified at 312 may be a type 1, single-panel codebook that is designed to support more than 32 CSI-RS ports and ranks from 2-8.

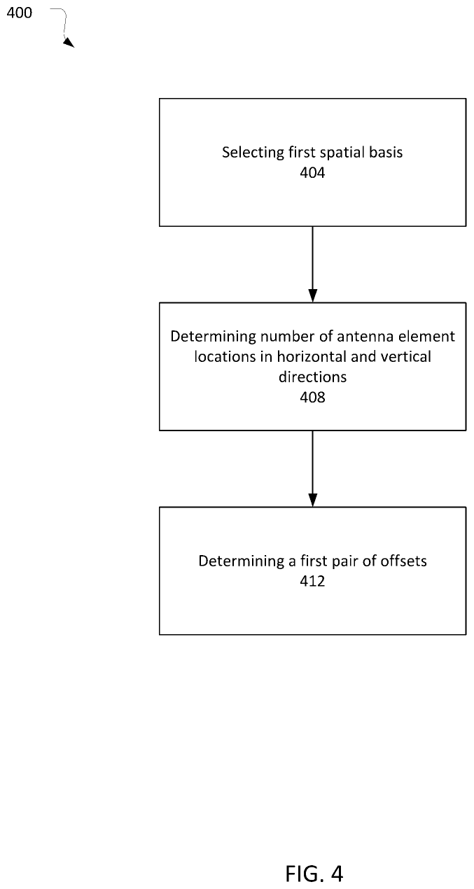

FIG. 4 illustrates an operation flow/algorithmic structure 400 in accordance with some embodiments. The operation flow/algorithmic structure 400 may be implemented by a UE such as UE 104, UE 600, or components therein, for example, processors 604.

The operation flow/algorithmic structure 400 may include, at 404, selecting a first spatial basis. In some embodiments, the first spatial basis may be determined by analyzing various candidate beams based on a channel matrix determined by measuring a CSI-RS as described elsewhere herein.

The operation flow/algorithmic structure 400 may further include, at 408, determining a number of antenna elements locations in a horizontal and vertical directions. In some embodiments, the number of antenna element locations in the horizontal direction multiplied by the number of antenna element locations in the vertical direction may be equal to 24, 32, 36, 48, or 64, which corresponds to embodiments in which the base station has 48, 64, 72, 96, or 128 CSI-RS ports (as each location may be associated with two CSI-RS ports).

In some embodiments, the number of antenna element locations may be signaled to the UE from the base station. For example, the information may be transmitted in a configuration IE by RRC signaling.

The operation flow/algorithmic structure 400 may further include, at 412, determining a first pair of offsets. The first pair of offsets may be determined based on the number of locations in the vertical or horizontal directions. The first pair of offsets, when applied to the first spatial basis, may indicate a second spatial basis. In some embodiments, additional offset pairs may be applied to the first spatial basis to indicate additional spatial bases.

In some embodiments, for a rank 2 transmission, the first spatial basis may correspond to a first layer and the second spatial basis may correspond to a second layer as described with respect to aspect 1.2. Further, the first pair of offsets may be based on the number of antenna element locations in the vertical/horizontal directions and may be further selected from a candidate set of offset pairs as described with respect to aspect 1.2.

In some embodiments, for rank 3/4 transmissions, the first spatial basis may correspond to a pair of layers and the second spatial basis may correspond to one layer (for rank 3) or two layers (for rank 4) as described with respect to aspect 1.3. Further, the first pair of offsets may be based on the number of antenna element locations in the vertical/horizontal directions and may be further selected from a candidate set of offset pairs as described with respect to aspect 1.3.

In some embodiments, for rank 5/6 transmissions, the first spatial basis may correspond to a first pair of layers, the second spatial basis may correspond to a second pair of layers, and a third spatial basis may correspond to one layer (for rank 5) or two layers (for rank 6) as described with respect to aspect 1.5. Further, the first pair of offsets may be applied to the first spatial basis to indicate the second spatial basis, and a second pair of offsets may be applied to the first spatial basis to indicate the third spatial basis. The first and second pairs of offsets may be based on the number of antenna element locations in the vertical/horizontal directions as described with respect to aspect 1.5.

In some embodiments, for rank 7 transmissions, the first spatial basis may correspond to a first pair of layers, the second spatial basis may correspond to one layer, the third spatial basis may correspond to a second pair of layers, and a fourth spatial basis may correspond to a third pair of layers as described with respect to aspect 1.6. Further, the first pair of offsets may be applied to the first spatial basis to indicate the second spatial basis, a second pair of offsets may be applied to the first spatial basis to indicate the third spatial basis, and a third pair of offsets may be applied to the first spatial basis to indicate the fourth spatial basis. The first, second, and third pairs of offsets may be based on the number of antenna element locations in the vertical/horizontal directions as described with respect to aspect 1.6.

In some embodiments, for rank 8 transmissions, the first spatial basis may correspond to a first pair of layers, the second spatial basis may correspond to a second pair of layers, the third spatial basis may correspond to a third pair of layers, and a fourth spatial basis may correspond to a fourth pair of layers as described with respect to aspect 2.7. Further, the first pair of offsets may be applied to the first spatial basis to indicate the second spatial basis, a second pair of offsets may be applied to the first spatial basis to indicate the third spatial basis, and a third pair of offsets may be applied to the first spatial basis to indicate the fourth spatial basis. The first, second, and third pairs of offsets may be based on the number of antenna element locations in the vertical/horizontal directions as described with respect to aspect 1.7.

In some embodiments, the first spatial basis may be selected by analyzing a first plurality of beams in a vertical direction to identify a vertical beam value and analyzing a second plurality of beams in a horizontal direction to identify a horizontal beam value. The first spatial basis may be based on the vertical and horizontal beam values.

In some embodiments, the first plurality of beams in the vertical direction may be a subset of the total beams in the vertical direction. Similarly, the second plurality of beams in the horizontal direction may be a subset of the total beams in the horizontal direction. For example, the first and second pluralities may be determined as described with respect to aspects 1.4 and 1.8.

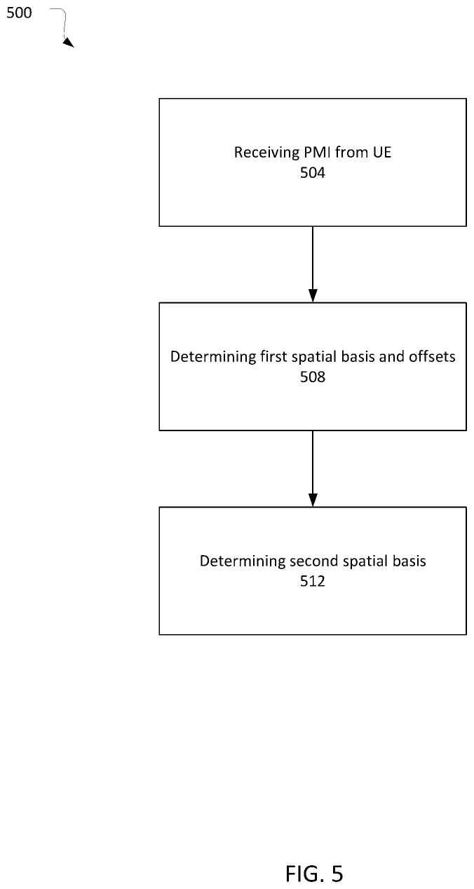

FIG. 5 illustrates an operation flow/algorithmic structure 500 in accordance with some embodiments. The operation flow/algorithmic structure 500 may be implemented by a base station such as base station 108, base station 700, or components therein, for example, processors 704.

The operation flow/algorithmic structure 400 may include, at 404, receiving a PMI from a UE.

The operation flow/algorithmic structure 400 may further include, at 408, determining a first spatial basis and a first pair of offsets based on the PMI. The first spatial basis may be for transmitting a first layer of a transmission having a rank of two or more.

The operation flow/algorithmic structure 400 may further include, at 412, determining a second spatial basis. The second spatial basis may be determined based on the first spatial basis and the offsets. The second spatial basis may be for transmitting a second layer of the transmission.

In some embodiments, the rank may be equal to three and the first spatial basis may also be used to transmit a third layer. This may be done as described with respect to aspect 1.3.

In some embodiments, the rank may be equal to four and both the first spatial basis and the second spatial basis may be used to transmit respective pairs of layers. This may be done as described with respect to aspect 1.3.

In some embodiments, the rank may be equal to five. In these embodiments, two spatial bases may be used to transmit respective pairs of layers, while a third spatial basis may be used to transmit a single layer. This may be done as described with respect to aspect 1.5.

In some embodiments, the rank may be equal to six. In these embodiments, three spatial bases may be used to transmit respective pairs of layers. This may be done as described with respect to aspect 1.5.

In some embodiments, the rank may be equal to seven. In these embodiments, three spatial bases may be used to transmit respective pairs of layers, while a fourth spatial basis may be used to transmit a single layer. This may be done as described with respect to aspect 1.6.

In some embodiments, the rank may be equal to eight. In these embodiments, four spatial bases may be used to transmit respective pairs of layers. This may be done as described with respect to aspect 1.7.

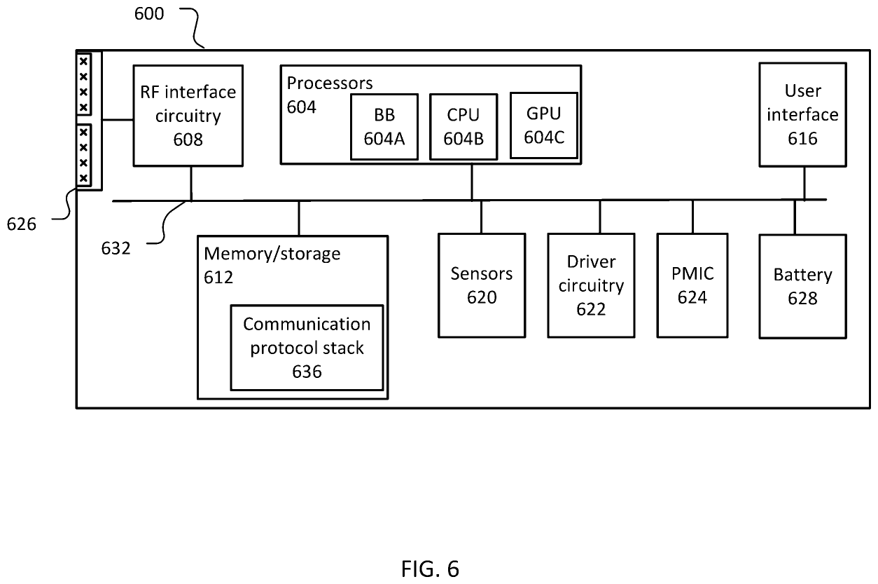

FIG. 6 illustrates an example UE 600 in accordance with some embodiments.

The UE 600 may be any mobile or non-mobile computing device, such as, for example, a mobile phone, a computer, a tablet, an industrial wireless sensor (for example, a microphone, a carbon dioxide sensor, a pressure sensor, a humidity sensor, a thermometer, a motion sensor, an accelerometer, a laser scanner, a fluid level sensor, an inventory sensor, an electric voltage/current meter, or an actuators), a video surveillance/monitoring device (for example, a camera), a wearable device (for example, a smart watch), or an Internet-of-things (IoT) device.

The UE 600 may include processors 604, RF interface circuitry 608, memory/storage 612, user interface 616, sensors 620, driver circuitry 622, power management integrated circuit (PMIC) 624, antenna structure 626, and battery 628. The components of the UE 600 may be implemented as integrated circuits (ICs), portions thereof, discrete electronic devices, or other modules, logic, hardware, software, firmware, or a combination thereof. The block diagram of FIG. 6 is intended to show a high-level view of some of the components of the UE 600. However, some of the components shown may be omitted, additional components may be present, and different arrangement of the components shown may occur in other implementations.

The components of the UE 600 may be coupled with various other components over one or more interconnects 632, which may represent any type of interface, input/output, bus (local, system, or expansion), transmission line, trace, optical connection, etc. that allows various circuit components (on common or different chips or chipsets) to interact with one another.

The processors 604 may include processor circuitry such as, for example, baseband processor circuitry (BB) 604A, central processor unit circuitry (CPU) 604B, and graphics processor unit circuitry (GPU) 604C. The processors 604 may include any type of circuitry or processor circuitry that executes or otherwise operates computer-executable instructions, such as program code, software modules, or functional processes from memory/storage 612 to cause the UE 600 to perform operations such as those described with respect to FIG. 3 or 4 or elsewhere herein.

In some embodiments, the baseband processor circuitry 604A may access a communication protocol stack 636 in the memory/storage 612 to communicate over a 3GPP compatible network. In general, the baseband processor circuitry 604A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 608.

The baseband processor circuitry 604A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 612 may include one or more non-transitory, computer-readable media that includes instructions (for example, communication protocol stack 636) that may be executed by one or more of the processors 604 to cause the UE 600 to perform various operations described herein. The memory/storage 612 include any type of volatile or non-volatile memory that may be distributed throughout the UE 600. In some embodiments, some of the memory/storage 612 may be located on the processors 604 themselves (for example, L1 and L2 cache), while other memory/storage 612 is external to the processors 604 but accessible thereto via a memory interface. The memory/storage 612 may include any suitable volatile or non-volatile memory such as, but not limited to, dynamic random-access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 608 may include transceiver circuitry and radio frequency front module (RFEM) that allows the UE 600 to communicate with other devices over a radio access network. The RF interface circuitry 608 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 626 and proceed to filter and amplify (with a low-noise amplifier) the signal. The signal may be provided to a receiver of the transceiver that down-converts the RF signal into a baseband signal that is provided to the baseband processor of the processors 604.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 626.

In various embodiments, the RF interface circuitry 608 may be configured to transmit/receive signals in a manner compatible with NR or other access technologies.

The antenna structure 626 may include antenna elements to convert electrical signals into radio waves to travel through the air and to convert received radio waves into electrical signals. The antenna elements may be arranged into one or more antenna panels. The antenna structure 626 may have antenna panels that are omnidirectional, directional, or a combination thereof to enable beamforming and multiple-input, multiple-output communications. The antenna structure 626 may include microstrip antennas, printed antennas fabricated on the surface of one or more printed circuit boards, patch antennas, phased array antennas, etc. The antenna structure 626 may have one or more panels designed for specific frequency bands including bands in FR1 or FR2.

The user interface 616 includes various input/output (I/O) devices designed to enable user interaction with the UE 600. The user interface 616 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 600.

The sensors 620 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 622 may include software and hardware elements that operate to control particular devices that are embedded in the UE 600, attached to the UE 600, or otherwise communicatively coupled with the UE 600. The driver circuitry 622 may include individual drivers allowing other components to interact with or control various input/output (I/O) devices that may be present within, or connected to, the UE 600. For example, driver circuitry 622 may include a display driver to control and allow access to a display device, a touchscreen driver to control and allow access to a touchscreen interface, sensor drivers to obtain sensor readings of sensors 620 and control and allow access to sensors 620, drivers to obtain actuator positions of electro-mechanic components or control and allow access to the electro-mechanic components, a camera driver to control and allow access to an embedded image capture device, audio drivers to control and allow access to one or more audio devices.

The PMIC 624 may manage power provided to various components of the UE 600. In particular, with respect to the processors 604, the PMIC 624 may control power-source selection, voltage scaling, battery charging, or DC-to-DC conversion.

In some embodiments, the PMIC 624 may control, or otherwise be part of, various power saving mechanisms of the UE 600. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 600 may power down for brief intervals of time and thus save power. If there is no data traffic activity for an extended period of time, then the UE 600 may transition off to an RRC_Idle state, where it disconnects from the network and does not perform operations such as channel quality feedback, handover, etc. The UE 600 goes into a very low power state and it performs paging where again it periodically wakes up to listen to the network and then powers down again. The UE 600 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 628 may power the UE 600, although in some examples the UE 600 may be mounted deployed in a fixed location and may have a power supply coupled to an electrical grid. The battery 628 may be a lithium-ion battery, a metal-air battery, such as a zinc-air battery, an aluminum-air battery, a lithium-air battery, and the like. In some implementations, such as in vehicle-based applications, the battery 628 may be a typical lead-acid automotive battery.

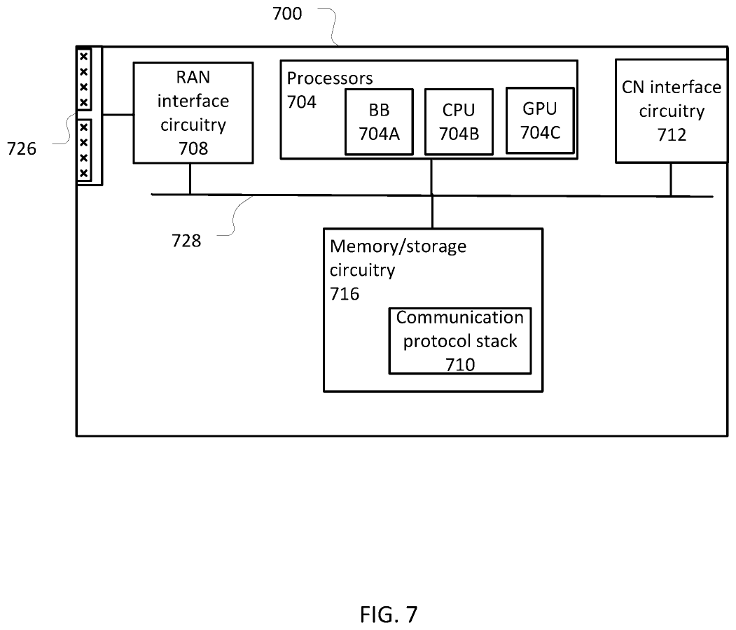

FIG. 7 illustrates an example base station 700 in accordance with some embodiments. The base station 700 may include processors 704, RF interface circuitry 708, core network (CN) interface circuitry 712, memory/storage circuitry 716, and antenna structure 726.

The components of the base station 700 may be coupled with various other components over one or more interconnects 728.

The processors 704, RF interface circuitry 708, memory/storage circuitry 716 (including communication protocol stack 710), antenna structure 726, and interconnects 728 may be similar to like-named elements shown and described with respect to FIG. 6.

The processors 704 may include any type of circuitry or processor circuitry that executes or otherwise operates computer-executable instructions, such as program code, software modules, or functional processes from memory/storage 716 to cause the base station 700 to perform operations such as those described with respect to FIG. 5 or elsewhere herein.

The CN interface circuitry 712 may provide connectivity to a core network, for example, a 5th Generation Core network (5GC) using a 5GC-compatible network interface protocol such as carrier Ethernet protocols, or some other suitable protocol. Network connectivity may be provided to/from the base station 700 via a fiber optic or wireless backhaul. The CN interface circuitry 712 may include one or more dedicated processors or FPGAs to communicate using one or more of the aforementioned protocols. In some implementations, the CN interface circuitry 712 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.

Example 1 includes a method to be performed by a user equipment (UE), the method comprising: determining a first number of antenna element locations, at a base station, in a vertical direction; determining a second number of antenna element locations, at the base station, in a horizontal direction, wherein the first number multiplied by the second number is equal to 24, 32, 36, 48 or 64; determining a vertical oversampling factor; determining a horizontal oversampling factor; and identifying a codebook based on the first number, the second number, the vertical oversampling factor, and the horizontal oversampling factor.

Example 2 includes the method of example one some other example herein, further comprising: determining the vertical oversampling factor and the horizontal oversampling factor based on radio resource control (RRC) signaling from the base station.

Example 3 includes the method of example one some other example herein, further comprising: determining the vertical oversampling factor and the horizontal oversampling factor based on the first and second numbers.

Example 4 includes the method of example 3 or some other example herein, further comprising: determining the vertical oversampling factor is two if the first number is greater than one; and determining the horizontal oversampling factor is two if the second number is greater than one.

Example 5 includes the method of example one some other example herein, wherein the codebook is a Type I, single-panel codebook for more than 32 channel state information-reference signal (CSI-RS) ports.

Example 6 includes a method of operating a user equipment (UE), the method comprising: selecting a first spatial basis for transmitting a first layer of a transmission having a rank of two or more; determining a first number of antenna element locations, at a base station, in a vertical direction; determining a second number of antenna element locations, at the base station, in a horizontal direction, wherein the first number multiplied by the second number is equal to 24, 32, 36, 48 or 64; and determining first and second offsets based on the first and second numbers, wherein the first and second offsets, applied to the first spatial basis, indicate a second spatial basis to be used for transmitting a second layer of the transmission.

Example 7 includes the method of example 6 or some other example herein, further comprising: determining a set of candidate offset values based on the first and second numbers; and selecting the first and second offsets from the set of candidate offset values.

Example 8 includes the method of example 7 or some other example herein, wherein the rank is two, k₁ is the first offset, k₂ is the second offset, N₁ is the first number, N₂ is the second number, O₁ is a vertical oversampling factor, O₂ is a horizontal oversampling factor, and determining a set of candidate offset values based on the first and second numbers comprises: if N₁>N₂>1, then {k₁, k₂}∈{(O₁, 0), (0, O₂), (O₁, O₂), (2O₁, 0), (2O₁, O₂), (3O₁, 0), (3O₁, O₂)}; and if N₁=N₂>1, then {k₁, k₂}∈{(O₁, 0), (0, O₂), (O₁, O₂), (2O₁, 0), (2O₁, O₂), (0, 2O₂), (O₁, 2O₂)}.

Example 9 includes the method of example 7 or some other example herein, wherein the rank is two, k₁ is the first offset, k₂ is the second offset, N₁ is the first number, N₂ is the second number, O₁ is a vertical oversampling factor, O₂ is a horizontal oversampling factor, and determining a set of candidate offset values based on the first and second numbers comprises: if N₁>N₂>1, then {k₁, k₂}∈{(2O₁, 0), (0, 2O₂), (4O₁, 0)}; and if N₁=N₂>1, then {k₁, k₂}∈{(2O₁, 0). (0, 2O₂), (2O₁, 2O₂)}.

Example 10 includes the method of example 7 or some other example herein, wherein the rank is three and the method further comprises: determining the first spatial basis for transmitting a third layer, wherein the first layer is associated with a column index 0 of a codebook, the second layer is associated with a column index 1 of the codebook, and the third layer is associated with a column index 2 of the codebook.

Example 11 includes the method of example 7 or some other example herein, wherein the rank is four and the method further comprises: determining the first spatial basis for transmitting a third layer; and determining the second spatial basis for transmitting a fourth layer, wherein the first layer is associated with a column index 0 of a codebook, the second layer is associated with a column index 1 of the codebook, the third layer is associated with a column index 2 of the codebook, and the fourth layer is associated with a column index 3 of the codebook.

Example 12 includes the method of example 10 or 11 or some other example herein, wherein k is the first offset, k₂ is the second offset, N₁ is the first number, N₂ is the second number, O₁ is a vertical oversampling factor, O₂ is a horizontal oversampling factor, and determining a set of candidate offset values based on the first and second numbers comprises: if N₁≥N₂>1, then {k₁, k_2}∈{(O₁, 0), (0, O_2), (O_1, O_2), (2O_1, 0)}; and if N₂=1, then {k₁, k₂}={(O₁, 0), (2O₂, 0), (3O₁, 0), (4O₁, 0)}.

Example 13 includes the method of example 12 or some other example herein, further comprising: generating a signal to include a precoding matrix indicator (PMI) to indicate the first spatial basis, the first offset, and the second offset.

Example 14 includes a method of example 6 or some other example herein, wherein the rank is five or six and the method further comprises: determining the first spatial basis for transmitting a third layer; determining the second spatial basis for transmitting a fourth layer; and determining a third spatial basis for transmitting a fifth layer, wherein the first layer is associated with a column index 0 of a codebook, the second layer is associated with a column index 2 of the codebook, the third layer is associated with a column index 1 of the codebook, the fourth layer is associated with a column index 3 of the codebook, and the fifth layer is associated with a column index 4 of the codebook.

Example 15 includes the method of example 14 or some other example herein, wherein the rank is six and the method further comprises: determining the third spatial basis for transmitting a sixth layer, wherein the sixth layer is associated with a column index 5 of the codebook.

Example 16 includes the method of example 14 or 15 or some other example herein, further comprising: determining third and fourth offsets, wherein the third and fourth offsets, applied to the first spatial basis, indicate the third spatial basis.

Example 17 includes the method of example 14 or 15 or some other example herein, wherein b_{0,0} is the first spatial basis, b_{1,1} is the second spatial basis, b_{2,2} is the third spatial basis, the first offset is k₁, the second offset is k₂, the third offset is k₃, the fourth offset is k₄, N₂ is the second number, O₁ is a vertical oversampling factor, O₂ is a horizontal oversampling factor, and: if N₂=1, then (k₁, k₂) is (O₁, 0) and (k₃, k₄) is (2O₁, 0); else, (k₁, k₂) is (O₁, 0) and (k₃, k₄) is (O₁, O₂).

Example 18 includes the method of example 6 or some other example herein, wherein the rank is seven and the method further comprises: determining the first spatial basis for transmitting a third layer; determining a third spatial basis for transmitting a fourth layer and a fifth layer; and determining a fourth spatial basis for transmitting a sixth layer and a seventh layer, wherein the first layer is associated with a column index 0 of a codebook, the second layer is associated with a column index 2 of the codebook, the third layer is associated with a column index 1 of the codebook, the fourth layer is associated with a column index 3 of the codebook, the fifth layer is associated with a column index 4 of the codebook, the sixth layer is associated with a column index 5 of the codebook, the seventh layer is associated with a column index 6 of the codebook.

Example 19 includes the method of example 18 or some other example herein, further comprising: determining third and fourth offsets, wherein the third and fourth offsets, applied to the first spatial basis, indicate the third spatial basis; and determining fifth and sixth offsets, wherein the fifth and sixth offsets, applied to the first spatial basis, indicate the fourth spatial basis.

Example 20 includes the method of example 19 or some other example herein, wherein b_{0,0} is the first spatial basis, b_{1,1} is the second spatial basis, b_{2,2} is the third spatial basis, b_{3,3} is the fourth spatial basis, the first offset is k₁, the second offset is k₂, the third offset is k₃, the fourth offset is k₄, the fifth offset is k₅, the sixth offset is k₆, N₂ is the second number, O₁ is a vertical oversampling factor, O₂ is a horizontal oversampling factor, and: if N₂=1, then (k₁, k₂) is (O₁, 0), (k₃, k₄) is (2O₁, 0), and (k₃, k₄) is (3O₁, 0); else, (k₁, k₂) is (O₁, 0), (k₃, k₄) is (0, O₂), and (k₃, k₄) is (O₁, O₂).

Example 21 includes the method of example 6 or some other example herein, wherein the rank is eight and the method further comprises: determining the first spatial basis for transmitting a third layer; determining the second spatial basis for transmitting a fourth layer; determining a third spatial basis for transmitting a fifth layer and a sixth layer; and determining a fourth spatial basis for transmitting a seventh layer and an eighth layer, wherein the first layer is associated with a column index 0 of a codebook, the second layer is associated with a column index 2 of the codebook, the third layer is associated with a column index 1 of the codebook, the fourth layer is associated with a column index 3 of the codebook, the fifth layer is associated with a column index 4 of the codebook, the sixth layer is associated with a column index 5 of the codebook, the seventh layer is associated with a column index 6 of the codebook, and the eighth layer is associated with a column index 7 of the codebook.

Example 22 includes the method of example 21 or some other example herein, further comprising: determining third and fourth offsets, wherein the third and fourth offsets, applied to the first spatial basis, indicate the third spatial basis; and determining fifth and sixth offsets, wherein the fifth and sixth offsets, applied to the first spatial basis, indicate the fourth spatial basis.

Example 23 includes the method of example 22 or some other example herein, wherein b_{0,0} is the first spatial basis, b_{1,1} is the second spatial basis, b_{2,2} is the third spatial basis, b_{3,3} is the fourth spatial basis, the first offset is k₁, the second offset is k₂, the third offset is k₃, the fourth offset is k₄, the fifth offset is k₅, the sixth offset is k₆, N₂ is the second number, O₁ is a vertical oversampling factor, O₂ is a horizontal oversampling factor, and: if N₂=1, then (k₁, k₂) is (O₁, 0), (k₃, k₄) is (2O₁, 0), and (k₃, k₄) is (3O₁, 0); else, (k₁, k₂) is (O₁, 0), (k₃, k₄) is (0, O₂), and (k₃, k₄) is (O₁, O₂).

Example 24 includes a method of any one of examples 6-23 or some other example herein, wherein selecting the first spatial basis comprises: analyzing a first plurality of beams in a vertical direction to identify a vertical beam value, the first plurality being less than the first number multiplied by a vertical oversampling factor; analyzing a second plurality of beams in a horizontal direction to identify a horizontal beam value, the second plurality being less than the second number multiplied by a horizontal oversampling factor; and selecting the first spatial basis based on the vertical beam value and the horizontal beam value.

Example 25 includes the method of example 24 some other example herein, wherein the base station has x channel state information-reference signal (CSI-RS) ports, where x is 48, 64, 72, 96 or 128, N is the first number, and the first plurality is equal to N*O₁, where O₁ is the vertical oversampling factor and N=N₁/2 if x=48, N=N₁/4 if x=64, 96, or 128, and N=N₁/3 if x=72.

Example 26 includes the method of example 24 some other example herein, wherein N₂ is the second number, and the second plurality is equal to M*O₂, where O₂ is the horizontal oversampling factor and M=N₂ if N₂≤3, M=N₂/2 if N₂>3.

Example 27 includes a method of operating a base station configured with more than 32 channel state information-reference signal (CSI-RS) ports, the method comprising: receiving a precoding matrix indicator (PMI) from a user equipment (UE); and determining, based on the PMI, a first spatial basis for transmitting a first layer of a transmission having a rank of two or more; determining, based on the PMI, first and second offsets; and determining, based on the first spatial basis and the first and second offsets, a second spatial basis to be used for transmitting a second layer of the transmission.

Example 28 includes the method of example 27 or some other example herein, wherein the rank is three and the method further comprises: determining the first spatial basis for transmitting a third layer, wherein the first layer is associated with a column index 0 of a codebook, the second layer is associated with a column index 1 of the codebook, and the third layer is associated with a column index 2 of the codebook.

Example 29 includes the method of example 27 or some other example herein, wherein the rank is four and the method further comprises: determining the first spatial basis for transmitting a third layer; and determining the second spatial basis for transmitting a fourth layer, wherein the first layer is associated with a column index 0 of a codebook, the second layer is associated with a column index 1 of the codebook, the third layer is associated with a column index 2 of the codebook, and the fourth layer is associated with a column index 3 of the codebook.

Example 30 includes the method of example 27 or some other example herein, wherein the rank is five or six and the method further comprises: determining the first spatial basis for transmitting a third layer; determining the second spatial basis for transmitting a fourth layer; and determining a third spatial basis for transmitting a fifth layer, wherein the first layer is associated with a column index 0 of a codebook, the second layer is associated with a column index 2 of the codebook, the third layer is associated with a column index 1 of the codebook, the fourth layer is associated with a column index 3 of the codebook, and the fifth layer is associated with a column index 4 of the codebook.

Example 31 includes the method of example 27 or some other example herein, wherein the rank is seven and the method further comprises: determining the first spatial basis for transmitting a third layer; determining a third spatial basis for transmitting a fourth layer and a fifth layer; and determining a fourth spatial basis for transmitting a sixth layer and a seventh layer, wherein the first layer is associated with a column index 0 of a codebook, the second layer is associated with a column index 2 of the codebook, the third layer is associated with a column index 1 of the codebook, the fourth layer is associated with a column index 3 of the codebook, the fifth layer is associated with a column index 4 of the codebook, the sixth layer is associated with a column index 5 of the codebook, the seventh layer is associated with a column index 6 of the codebook.

Example 32 includes the method of example 27 or some other example herein, wherein the rank is eight and the method further comprises: determining the first spatial basis for transmitting a third layer; determining the second spatial basis for transmitting a fourth layer; determining a third spatial basis for transmitting a fifth layer and a sixth layer; and determining a fourth spatial basis for transmitting a seventh layer and an eighth layer, wherein the first layer is associated with a column index 0 of a codebook, the second layer is associated with a column index 2 of the codebook, the third layer is associated with a column index 1 of the codebook, the fourth layer is associated with a column index 3 of the codebook, the fifth layer is associated with a column index 4 of the codebook, the sixth layer is associated with a column index 5 of the codebook, the seventh layer is associated with a column index 6 of the codebook, and the eighth layer is associated with a column index 7 of the codebook.

Another example may include an apparatus comprising means to perform one or more elements of a method described in or related to any of examples 1-32, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-32, or any other method or process described herein.

Another example may include an apparatus comprising logic, modules, or circuitry to perform one or more elements of a method described in or related to any of examples 1-32, or any other method or process described herein.

Another example may include a method, technique, or process as described in or related to any of examples 1-32, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-32, or portions thereof.

Another example may include a signal as described in or related to any of examples 1-32, or portions or parts thereof.

Another example may include a datagram, information element, packet, frame, segment, PDU, or message as described in or related to any of examples 1-32, or portions or parts thereof, or otherwise described in the present disclosure.

Another example may include a signal encoded with data as described in or related to any of examples 1-32, or portions or parts thereof, or otherwise described in the present disclosure.

Another example may include a signal encoded with a datagram, IE, packet, frame, segment, PDU, or message as described in or related to any of examples 1-32, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-32, or portions thereof.

Another example may include a computer program comprising instructions, wherein execution of the program by a processing element is to cause the processing element to carry out the method, techniques, or process as described in or related to any of examples 1-32, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1.-25. (canceled)

26. An apparatus comprising:
processing circuitry to:
identify a first number of antenna element locations, at a base station, in a vertical direction;
identify a second number of antenna element locations, at the base station, in a horizontal direction, wherein the first number multiplied by the second number is equal to 24, 32, 36, 48 or 64;
determine a vertical oversampling factor;
determine a horizontal oversampling factor; and
identify a codebook based on the first number, the second number, the vertical oversampling factor, and the horizontal oversampling factor; and
interface circuitry coupled with the processing circuitry to enable communication.

27. The apparatus of claim 26, wherein the processing circuitry is further to:
determine the vertical oversampling factor is two if the first number is greater than one; and
determine the horizontal oversampling factor is two if the second number is greater than one.

28. The apparatus of claim 26, wherein: the first number is 8 and the second number is 3; the first number is 6 and the second number is 4; the first number is 16 and the second number is 2; the first number is 8 and the second number is 4; the first number is 16 and the second number is 4; or the first number is 8 and the second number is 8.

29. A method comprising:
selecting a first spatial basis for transmitting a first layer of a transmission having a rank of two or more;
identifying a first number of antenna element locations, at a base station, in a vertical direction;
identifying a second number of antenna element locations, at the base station, in a horizontal direction, wherein the first number multiplied by the second number is equal to 24, 32, 36, 48 or 64; and
determining first and second offsets based on the first and second numbers, wherein the first and second offsets, applied to the first spatial basis, indicate a second spatial basis to be used for transmitting a second layer of the transmission.

30. The method of claim 29, further comprising:
determining a set of candidate offset values based on the first and second numbers; and
selecting the first and second offsets from the set of candidate offset values.

31. The method of claim 30, wherein the rank is two, k₁ is the first offset, k₂ is the second offset, N₁ is the first number, N₂ is the second number, O₁ is a vertical oversampling factor, O₂ is a horizontal oversampling factor, and determining a set of candidate offset values based on the first and second numbers comprises:
if N₁>N₂>1, then {k₁, k₂}∈{(O₁, 0), (0, O₂), (O₁, O₂), (2O₁, 0), (2O₁, O₂), (3O₁, 0), (3O₁, O₂)}; and
if N₁=N₂>1, then {k₁, k₂}={(O₁, 0), (0, O₂), (O₁, O₂), (2O₁, 0), (2O₁, O₂), (0, 2O₂), (O₁, 2O₂)}.

32. The method of claim 30, wherein the rank is two, k₁ is the first offset, k₂ is the second offset, N₁ is the first number, N₂ is the second number, O₁ is a vertical oversampling factor, O₂ is a horizontal oversampling factor, and determining a set of candidate offset values based on the first and second numbers comprises:
if N₁>N₂>1, then {k₁, k₂}={(2O₁, 0), (0, 2O₂), (4O₁, 0)}; and
if N₁=N₂>1, then {k₁, k₂}∈{(2O₁, 0), (0, 2O₂), (2O₁, 2O₂)}.

33. The method of claim 30, wherein the rank is four and the method further comprises:
determining the first spatial basis for transmitting a third layer; and
determining the second spatial basis for transmitting a fourth layer,
wherein the first layer is associated with a column index 0 of a codebook, the second layer is associated with a column index 1 of the codebook, the third layer is associated with a column index 2 of the codebook, and the fourth layer is associated with a column index 3 of the codebook.

34. The method of claim 33, wherein k₁ is the first offset, k₂ is the second offset, N₁ is the first number, N₂ is the second number, O₁ is a vertical oversampling factor, O₂ is a horizontal oversampling factor, and determining a set of candidate offset values based on the first and second numbers comprises:
if N₁≥N₂>1, then {k₁, k_2}={(O₁, 0), (0, O_2), (O_1, O_2), (2O_1, 0)}; and
if N₂=1, then {k₁, k₂}∈{(O₁, 0), (2O₂, 0), (3O₁, 0), (4O₁, 0)}.

35. The method of claim 29, wherein the rank is five or six and the method further comprises:
determining the first spatial basis for transmitting a third layer;
determining the second spatial basis for transmitting a fourth layer; and
determining a third spatial basis for transmitting a fifth layer,
wherein the first layer is associated with a column index 0 of a codebook, the second layer is associated with a column index 2 of the codebook, the third layer is associated with a column index 1 of the codebook, the fourth layer is associated with a column index 3 of the codebook, and the fifth layer is associated with a column index 4 of the codebook.

36. The method of claim 35, further comprising:
determining third and fourth offsets, wherein the third and fourth offsets, applied to the first spatial basis, indicate the third spatial basis.

37. The method of claim 35, wherein b_{0,0} is the first spatial basis, b_{1,1} is the second spatial basis, b_{2,2} is the third spatial basis, the first offset is k₁, the second offset is k₂, the third offset is k₃, the fourth offset is k₄, N₂ is the second number, O₁ is a vertical oversampling factor, O₂ is a horizontal oversampling factor, and:
if N₂=1, then (k₁, k₂) is (O₁, 0) and (k₃, k₄) is (2O₁, 0); else, (k₁, k₂) is (O₁, 0) and (k₃, k₄) is (O₁, O₂).

38. The method of claim 29, wherein the rank is eight and the method further comprises:
determining the first spatial basis for transmitting a third layer;
determining the second spatial basis for transmitting a fourth layer;
determining a third spatial basis for transmitting a fifth layer and a sixth layer; and
determining a fourth spatial basis for transmitting a seventh layer and an eighth layer,
wherein the first layer is associated with a column index 0 of a codebook, the second layer is associated with a column index 2 of the codebook, the third layer is associated with a column index 1 of the codebook, the fourth layer is associated with a column index 3 of the codebook, the fifth layer is associated with a column index 4 of the codebook, the sixth layer is associated with a column index 5 of the codebook, the seventh layer is associated with a column index 6 of the codebook, and the eighth layer is associated with a column index 7 of the codebook.

39. The method of claim 38, further comprising:
determining third and fourth offsets, wherein the third and fourth offsets, applied to the first spatial basis, indicate the third spatial basis; and
determining fifth and sixth offsets, wherein the fifth and sixth offsets, applied to the first spatial basis, indicate the fourth spatial basis.

40. The method of claim 39, wherein b_{0,0} is the first spatial basis, b_{1,1} is the second spatial basis, b_{2,2} is the third spatial basis, b_{3,3} is the fourth spatial basis, the first offset is k₁, the second offset is k₂, the third offset is k₃, the fourth offset is k₄, the fifth offset is k₅, the sixth offset is k₆, N₂ is the second number, O₁ is a vertical oversampling factor, O₂ is a horizontal oversampling factor, and:
if N₂=1, then (k₁, k₂) is (O₁, 0), (k₃, k₄) is (2O₁, 0), and (k₃, k₄) is (3O₁, 0); else, (k₁, k₂) is (O₁, 0), (k₃, k₄) is (0, O₂), and (k₃, k₄) is (O₁, O₂).

41. The method of claim 29, further comprising:
generating a signal to include a precoding matrix indicator (PMI) to indicate the first spatial basis, the first offset, and the second offset.

42. The method of claim 29, wherein selecting the first spatial basis comprises:
analyzing a first plurality of beams in a vertical direction to identify a vertical beam value, the first plurality being less than the first number multiplied by a vertical oversampling factor;
analyzing a second plurality of beams in a horizontal direction to identify a horizontal beam value, the second plurality being less than the second number multiplied by a horizontal oversampling factor; and
selecting the first spatial basis based on the vertical beam value and the horizontal beam value.

43. The method of claim 42, wherein the base station has x channel state information-reference signal (CSI-RS) ports, where x is 48, 64, 72, 96 or 128, N₁ is the first number, the first plurality is equal to N*O₁, where O₁ is the vertical oversampling factor and N=N₁/2 if x=48, N=N₁/4 if x=64, 96, or 128, and N=N₁/3 if x=72, N₂ is the second number, and the second plurality is equal to M*O₂, where O₂ is the horizontal oversampling factor and M=N₂ if N₂≤3, M=N₂/2 if N₂>3.

44. A method comprising:
generating one or more channel state information-reference signals (CSI-RSs) for transmission using more than 32 CSI-RS ports;
receiving a precoding matrix indicator (PMI) from a user equipment (UE); and
determining, based on the PMI, a first spatial basis for transmitting a first layer of a transmission having a rank of two or more;
determining, based on the PMI, first and second offsets; and
determining, based on the first spatial basis and the first and second offsets, a second spatial basis to be used for transmitting a second layer of the transmission.

45. The method of claim 44, wherein the rank is three and the method further comprises:
determining the first spatial basis for transmitting a third layer, wherein the first layer is associated with a column index 0 of a codebook, the second layer is associated with a column index 1 of the codebook, and the third layer is associated with a column index 2 of the codebook.
